(19) United States
(12) Patent Application Publication
(10) Pub. No.: US 2026/0208417 A1
(43) Pub. Date: Jul. 23, 2026

(54) INJECTION MOLDING MACHINE

(71) Applicant: Sodick Co., Ltd., Kanagawa (JP)

(72) Inventor: Tadashi MORIKAWA, Kanagawa (JP)

(73) Assignee: Sodick Co., Ltd., Kanagawa (JP)

(21) Appl. No.: 19/357,084

(22) Filed: Oct. 14, 2025

(30) Foreign Application Priority Data
Nov. 15, 2024 (JP) 2024-199404

(51) Int. Cl. B29C 45/50

(52) U.S. Cl. CPC B29C 45/5008; B29C 2045/5024

(57) ABSTRACT

Provided is an injection molding machine that includes a screw in a cylinder, a drive shaft having a screw thread on an outer peripheral surface, an electric motor having a stator and a rotor, and a one-way clutch having an outer ring and an inner ring. The outer ring is movable in an axial direction and rotation thereof is restricted relative to the stator, the inner ring is fixed to the drive shaft, the drive shaft is connected to a rear end of the screw, driving of the rotor is transmitted to the drive shaft via the screw thread, and a first direction in which the one-way clutch allows rotation of the inner ring is a direction in which the screw thread tightens in response to rotating the rotor in the first direction.

### CROSS-REFERENCE TO RELATED APPLICATION

This application claims the priority benefits of Japanese application No. 2024-199404, filed on Nov. 15, 2024. The entirety of the above-mentioned patent application is hereby incorporated by reference herein and made a part of this specification.

### BACKGROUND

### Technical Field

The disclosure relates to an injection molding machine. The disclosure particularly relates to a backflow prevention mechanism in an injection molding machine that includes two independent cylinders.

### Description of Related Art

In the field of injection molding, an injection molding machine is known that includes a first cylinder having an injection shaft and additionally provides a second cylinder that is independent from the first cylinder for plasticizing or mixing molding material (e.g., Patent Document 1 (Japanese Patent Application Laid-Open (JP-A) No. 2013-220600) below). The second cylinder is a plasticizing cylinder having a screw (called a “plasticizing screw”) for plasticizing the molding material in the case of the molding material being thermoplastic resin, and is a mixing cylinder having a screw (called a “mixing screw”) for mixing the molding material in the case of the molding material being thermosetting resin. Here, “injection shaft” refers to an injection plunger or injection screw disposed inside the first cylinder as an injection cylinder, and hereinafter, the term “injection shaft” is used as a term encompassing these structures.

Such injection molding machines include a type called screw preplasticizer. In a screw preplasticizer type injection molding machine, a first cylinder as an injection cylinder and a second cylinder as, for example, a plasticizing cylinder are connected by a communication path, and by rotation of a plasticizing screw in the plasticizing cylinder, molten molding material is sent to the injection cylinder via the communication path, and the molten material is metered in the injection cylinder. Thereafter, by driving the injection shaft, the molten material is injected from the injection cylinder into the interior of a mold.

In screw preplasticizer type injection molding machines, for the purpose of preventing backflow of molding material from the injection cylinder to the plasticizing cylinder or mixing cylinder, a “backflow prevention operation” is executed after metering of the molding material and before injection into the mold. This backflow prevention operation involves advancing the plasticizing screw or mixing screw inside the second cylinder in the axial direction to block the communication path with the screw tip end. The backflow prevention operation prevents backflow of the molding material to the second cylinder and enables more accurate injection of resin into the mold.

However, the introduction of backflow prevention operation requires a mechanism for realizing forward and backward movement of the screw in the axial direction in addition to rotation of the screw inside the second cylinder. For example, in the injection unit described in Patent Document 1 mentioned above, by a combination of two one-way clutches having different directions that allow rotation and a cam mechanism, rotation of the screw and movement along the axial direction are switched according to the rotation direction of the rotor of the motor. The electric injection molding machine described in Patent Document 2 (Japanese Patent Application Laid-Open (JP-A) No. H05-345337) describes a mechanism capable of switching between rotation of an inline screw and movement along the axial direction by a combination of a dog clutch, an electromagnetic powder clutch, and an electromagnetic clutch.

As described above, conventionally, achieving both rotation and forward/backward movement of the screw requires a complex configuration such as incorporating two or more clutches in the screw drive mechanism, and injection molding machines tend to become larger and more complex as a whole. Under such circumstances, there is a demand for realizing backflow prevention operation with a simpler configuration.

### SUMMARY

According to the disclosure, the following invention is provided.
[1] An injection molding machine having a first cylinder having an injection shaft and a second cylinder connected to the first cylinder via a communication path, the injection molding machine including: a screw accommodated inside the second cylinder; a drive shaft having a screw thread on an outer peripheral surface, an electric motor having a stator and a rotor; and a one-way clutch having an outer ring and an inner ring. The outer ring of the one-way clutch is movable in an axial direction of the screw and restricted from relative rotation with respect to the stator, the inner ring of the one-way clutch is fixed to the drive shaft, the drive shaft is connected to a rear end of the screw coaxially with the screw, driving of the rotor is transmitted to the drive shaft via the screw thread, and a first direction in which the one-way clutch allows rotation of the inner ring is a direction in which the screw thread tightens in response to rotating the rotor in the first direction.
[2] In the injection molding machine according to [1], the electric motor is controlled to rotate the screw in the first direction by rotating the rotor in the first direction to send molding material in the second cylinder to the first cylinder via the communication path, and then advance the screw along the axial direction by rotating the rotor in a second direction opposite to the first direction to close the communication path at a tip end of the screw.
[3] In the injection molding machine according to [1] or [2], the screw thread provided on the drive shaft is a reverse thread.
[4] The injection molding machine according to any one of [1] to [3], further including: a first shaft key; and a drive nut formed with an internal thread. The rotor of the electric motor has a hollow cylindrical shape, the drive nut is coupled to an inside of the cylindrical shape of the rotor with relative rotation with respect to the rotor being restricted by the first shaft key, and the screw thread of the drive shaft is engaged with the internal thread of the drive nut.
[5] The injection molding machine according to [4], further including: a second shaft key; and a clutch housing fixed to an outer peripheral surface of the outer ring of the one-way clutch. The electric motor includes: a housing that accommodates the stator and the rotor; and a front bracket having a through hole. The front bracket is positioned between the housing and the second cylinder, and the clutch housing is coupled to an inside of the through hole such that the clutch housing is movable in the axial direction of the screw by the second shaft key and relative rotation with respect to the front bracket is restricted.
[6] In the injection molding machine according to [5], a diameter of the clutch housing is equal to or less than a diameter of the drive nut.
[7] In the injection molding machine according to [6], the electric motor further includes an end bell connected to a rear end of the housing, the end bell includes a restriction member having a contact surface, the restriction member is configured to be capable of adjusting a position of the contact surface in the axial direction of the screw with respect to a rear end of the housing, and the drive nut is coupled to the rotor movably in the axial direction of the screw by the first shaft key.
[8] In the injection molding machine according to any one of [1] to [7], the first cylinder is an injection cylinder, the injection shaft is an injection plunger, the second cylinder is a plasticizing cylinder, and the screw is a plasticizing screw.
[9] In the injection molding machine according to any one of [1] to [7], the first cylinder is an injection cylinder, the injection shaft is an injection plunger, the second cylinder is a mixing cylinder, and the screw is a mixing screw.

### BRIEF DESCRIPTION OF THE DRAWINGS

FIG. 1 is a diagram showing an example of an injection molding machine according to an embodiment of the disclosure.

FIG. 2 is a perspective view showing an injection unit 10, which is mainly related to injection of molding material in the injection molding machine 1 shown in FIG. 1, with its exterior removed.

FIG. 3 is a schematic partial cross-sectional view of the injection unit 10.

FIG. 4 is a schematic exploded perspective view of the screw drive device 18.

FIG. 5 is a schematic vertical cross-sectional view of the screw drive device 18.

FIG. 6 is an exploded perspective view showing the front bracket 80F and its surroundings.

FIG. 7 is an exploded perspective view showing the front bracket 80F and its surroundings.

FIG. 8 is a schematic vertical cross-sectional view for describing the arrangement of each portion of the screw drive device 18 before the start of the plasticizing process.

FIG. 9 is a schematic cross-sectional view for describing the disassembly of the screw drive device 18 into three units.

FIG. 10 is a schematic diagram showing the end unit 18Z shown in FIG. 9 in an exploded view, and is a diagram describing an example in which the cylindrical portion 80bc and the plate portion 80bp are coupled with the bolt Sab during stroke adjustment of the screw 12S.

### DESCRIPTION OF THE EMBODIMENTS

According to the disclosure, by connecting a shaft connected to a screw to a rotor of a hollow shaft motor via a screw thread, it becomes possible to switch between rotation of the screw and movement along the axial direction while reducing the number of one-way clutches. That is, it is possible to realize a backflow prevention operation with a simpler configuration.

Hereinafter, embodiments of the disclosure will be described with reference to the drawings. The features shown in the following embodiments may be combined with each other. Further, each characteristic feature constitutes an invention independently. It is noted that in the drawings shown below, illustration of some members may be omitted to avoid becoming excessively complex.

### 1. Overall Configuration of Injection Molding Machine

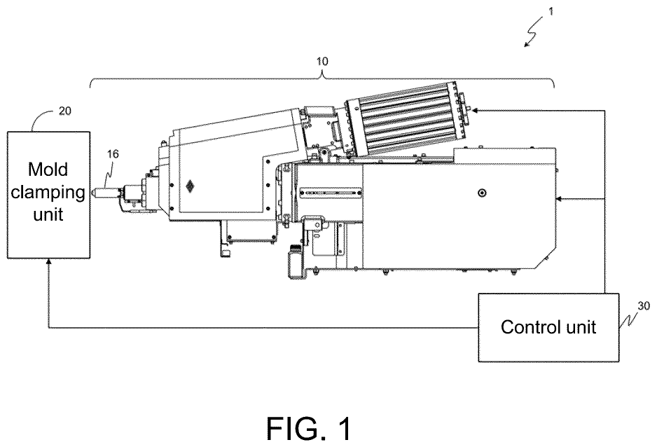

FIG. 1 shows an example of an injection molding machine according to an embodiment of the disclosure. The injection molding machine 1 shown in FIG. 1 is generally configured by combining three units. More specifically, the injection molding machine 1 includes an injection unit 10, a mold clamping unit 20, and a control unit 30.

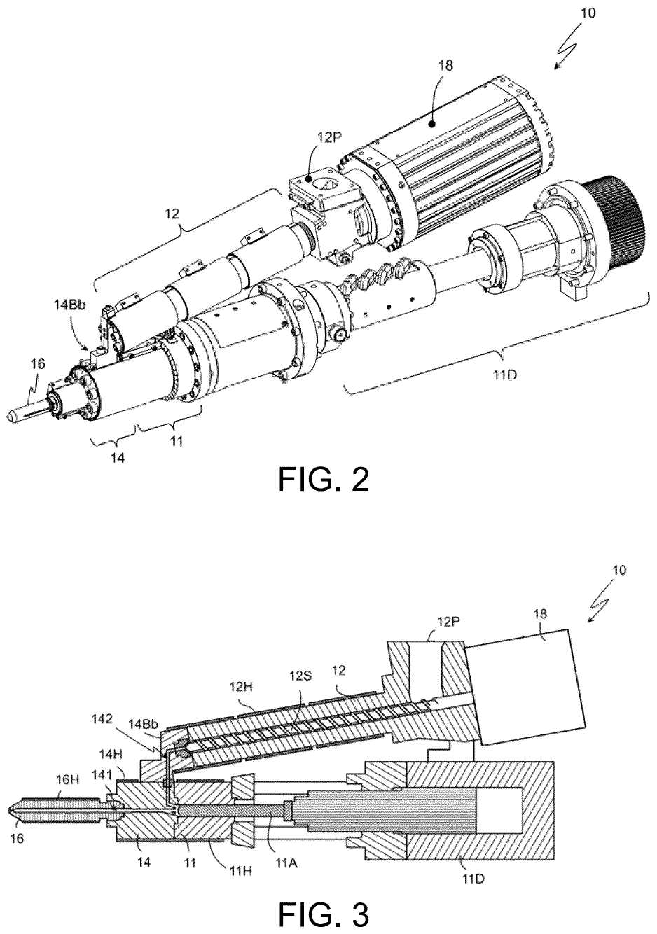

In the embodiment of the disclosure, the injection unit 10 of the injection molding machine 1 is assumed to be a device having two independent cylinders (also called barrels) connected to each other via a communication path. FIG. 2 shows the injection unit 10, which is mainly related to injection of molding material in the injection molding machine 1 shown in FIG. 1, with its exterior removed. In the configuration illustrated in FIG. 2, the injection unit 10 has a first cylinder 11 and a second cylinder 12 with a screw disposed inside.

The injection unit 10 further includes a nozzle cylinder 14, a junction 14Bb, and an injection nozzle 16. The nozzle cylinder 14 is positioned between the first cylinder 11 and the injection nozzle 16 in the axial direction of the first cylinder 11. The junction 14Bb connects the tip end of the second cylinder 12 to the side portion of the nozzle cylinder 14. In other words, the second cylinder 12 is connected to the first cylinder 11 by the nozzle cylinder 14 and the junction 14Bb.

The mold clamping unit 20 of the injection molding machine 1 is configured to detachably mount a mold (not shown in FIG. 1), and has a mechanism that opens and closes the mounted mold based on control by the control unit 30. The mold clamping unit 20 has a mechanism that applies pressure (generally called “mold clamping force”) to further tighten the mold in a closed state. Molten or liquid molding material is injected from the injection nozzle 16 mounted to the tip end of the nozzle cylinder 14 of the injection unit 10 into the mold in a state of being tightened by the mold clamping unit 20.

The control unit 30 of the injection molding machine 1 has at least one processor and at least one memory, and controls operations of the injection unit 10 and the mold clamping unit 20 according to instructions described in an operation program stored in the memory. As described later, the injection unit 10 includes a motor that operates a screw accommodated inside the second cylinder 12, and the control unit 30 has a function of controlling the rotational speed and rotation direction of a rotor of the motor of the injection unit 10. It is noted that in FIG. 1, the injection unit 10 and the control unit 30 are shown as independent devices, but for example, these may be integrated into a single device by incorporating the control unit 30 into the injection unit 10.

### Injection Unit 10

Details of the configuration of the injection unit 10 will be described below. FIG. 3 schematically shows a partial cross-section of the injection unit 10. First, attention is focused on the first cylinder 11. The first cylinder 11 is an injection cylinder having an injection shaft 11A inside, and here, the injection shaft 11A is an injection plunger configured to be capable of reciprocating motion along the axis of the first cylinder 11.

An injection drive device 11D is disposed at the rear end of the first cylinder 11, which is the opposite side from the above-mentioned injection nozzle 16 in the axial direction. The injection drive device 11D is an arbitrary actuator that drives the injection shaft 11A back and forth inside the first cylinder 11 based on instructions from the control unit 30. As the injection drive device 11D, an electric cylinder or a hydraulic cylinder may be exemplified. Hereinafter, in this specification, the side closer to the mold clamping unit 20 in the axial direction of each of the first cylinder 11 and the second cylinder 12 (the left side in FIG. 3) may be called “front” or “front side,” and the opposite side from the mold clamping unit 20 may be called “rear” or “rear side.

As described with reference to FIG. 2, the nozzle cylinder 14 is positioned between the front end of the first cylinder 11 and the injection nozzle 16. The junction 14Bb is positioned between the front end of the second cylinder 12 and the nozzle cylinder 14. As shown in FIG. 3, the nozzle cylinder 14 has inside thereof a flow path 141 that communicates from the space inside the first cylinder 11 to the space inside the injection nozzle 16, and a portion of a communication path 142 that defines a flow path connecting the space inside the first cylinder 11 and the space inside the second cylinder 12. The junction 14Bb has the remaining portion of the communication path 142 inside thereof. It is noted that it is not essential that the junction 14Bb be a separate member from the nozzle cylinder 14 that may be separated from the nozzle cylinder 14. The structure including the nozzle cylinder 14 and the first cylinder 11 may be a single member formed as an integrated structure.

A heater 14H (e.g., a band heater) for temperature control may be mounted to the outer peripheral surface of the nozzle cylinder 14. Similarly, the first cylinder 11 and the injection nozzle 16 may also be configured to be heatable to a predetermined temperature by having a heater 11H (e.g., a band heater) and a heater 16H (e.g., a coil heater) wound around their outer peripheral surfaces, respectively. Furthermore, the junction 14Bb may also have a heater for temperature control.

Next, attention is focused on the second cylinder 12. As schematically shown in FIG. 3, the front end of the second cylinder 12 is connected to the junction 14Bb, and the above-mentioned communication path 142 communicates with the space inside the second cylinder 12 through the inside of the junction 14Bb.

The second cylinder 12 has a hopper 12P into which molding material is fed near the rear end thereof. Similar to the first cylinder 11, a heater 12H (e.g., a band heater) is mounted to the outer peripheral surface of the second cylinder 12.

A screw 12S is accommodated inside the second cylinder 12. The screw 12S is a plasticizing screw or a mixing screw. In both cases where the screw 12S is a plasticizing screw and a mixing screw, since the second cylinder 12 includes the screw 12S, the injection unit 10 is called a screw preplasticizer type injection unit.

As will be described later with reference to the drawings, in the embodiment of the disclosure, this screw 12S is configured to be rotatable around the axial direction of the second cylinder 12 and movable back and forth along the axial direction with a predetermined stroke by a mechanism of a screw drive device 18 disposed at the rear end of the second cylinder 12. Hereinafter, unless otherwise specified, “axial direction” refers to “the axial direction of the second cylinder 12.”

The screw 12S is, for example, a plasticizing screw that plasticizes molding material in the case of the molding material fed from the hopper 12P being thermoplastic resin, and the second cylinder 12 functions as a plasticizing cylinder. The plasticizing screw typically has a screw groove formed in a spiral shape and may be divided into, for example, three zones from the base portion to the tip end portion. That is, the plasticizing screw may have, in this order from the base portion to the tip end portion, a feed section, a compression section, and a metering section. The screw groove on the side surface of the plasticizing screw is generally formed in a shape that is shallower in the metering section compared to the feed section and becomes shallower toward the metering section in the compression section. By rotation of the plasticizing screw, the molding material is plasticized while moving through the plasticizing cylinder from the base portion to the tip end portion of the plasticizing screw.

Alternatively, the screw 12S may be a mixing screw that mixes molding material. In other words, the second cylinder 12 may be a mixing cylinder for mixing thermosetting resin as molding material. The mixing screw has at least a mixing section, and the mixing section is provided with, for example, a structure called dalmage or maddock. For example, the mixing section includes multiple convex portions on the surface thereof. These multiple convex portions may be provided, for example, by forming multiple spiral grooves that intersect with each other on a cylindrical surface.

The thermosetting resin is composed of, for example, a liquid main agent and a curing agent, and is introduced into the mixing cylinder with pressure from a supply device. The main agent and the curing agent are mixed by rotation of the mixing screw while moving through the mixing cylinder from the base portion to the tip end portion of the mixing screw by pressure according to discharge from the supply device. A feed section may be provided at the base portion of the mixing screw to facilitate movement of the molding material through the mixing cylinder from the base portion to the tip end portion of the mixing screw. In both cases where the screw 12S is a plasticizing screw and a mixing screw, since the second cylinder 12 includes the screw 12S, the injection unit 10 is called a screw preplasticizer type injection unit.

### Screw Drive Device 18

Hereinafter, details of the screw drive device 18 will be described assuming that the screw 12S is a plasticizing screw. As understood from the following description, the screw drive device 18 includes a structure capable of achieving rotation of the screw 12S for plasticization of molding material and movement of the screw 12S along the axial direction for backflow prevention operation.

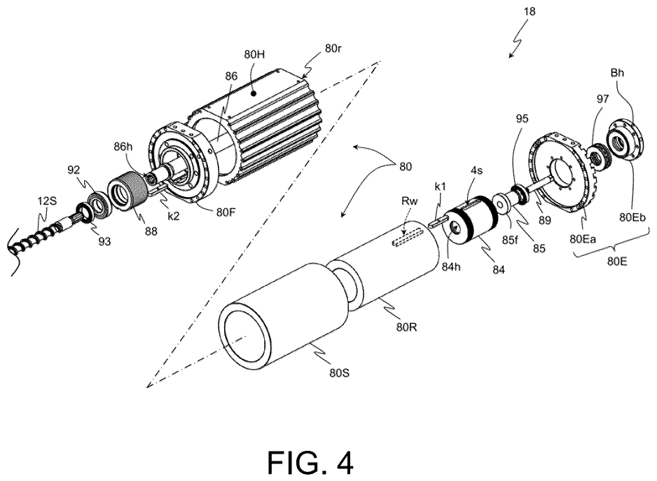

FIG. 4 shows the screw drive device 18 in an exploded view. The screw drive device 18 includes at least a motor for rotating the screw 12S and a one-way clutch, and is configured to be capable of switching between rotation and back-and-forth movement of the screw 12S by switching the rotation direction of the motor. In the example shown in FIG. 4, the screw drive device 18 includes a motor 80 and a one-way clutch 92.

The motor 80 has a stator 80S, a rotor 80R, and a housing 80H that accommodates the stator 80S and the rotor 80R. In this embodiment, the stator 80S is fixed to the inside of the housing 80H, and the rotor 80R is rotatably disposed inside the stator 80S.

In the configuration illustrated in FIG. 4, the motor 80 further has a front bracket 80F and an end bell 80E. Each of the front bracket 80F and the end bell 80E is fixed to the housing 80H by means such as screws. While the end bell 80E is connected to the rear end 80r of the housing 80H, the front bracket 80F is positioned between the housing 80H and the second cylinder 12. Here, the end bell 80E includes two parts. Specifically, the end bell 80E includes an annular first member 80Ea and a second member 80Eb fixed to the housing 80H.

In the embodiment of the disclosure, application of an electric motor as the motor 80, particularly a direct-drive hollow motor, is assumed. That is, here, the rotor 80R has a hollow cylindrical shape and is accommodated in the stator 80S coaxially with the stator 80S. The direct-drive motor has the advantage of being capable of generating high torque and allowing other members to be disposed inside the rotor 80R.

In this embodiment, a drive nut 84 is inserted inside the rotor 80R. The drive nut 84 is coupled to the inside of the cylindrical shape of the rotor 80R in a form where relative rotation with respect to the rotor 80R is restricted by, for example, a key. Here, a key sheet 4s is provided on the outer peripheral surface of the drive nut 84, a keyway Rw is provided on the inner peripheral surface of the rotor 80R, and a shaft key k1 (first shaft key) is disposed inside these slots. There is no particular limitation on the shape of the shaft key k1, and any of, for example, a square key, a flat key, a dowel key, a tapered key, etc. may be adopted.

At the rear end of the drive nut 84, a rear portion shaft 89 extending toward the end bell 80E of the motor 80 is positioned. The rear portion shaft 89 is coaxial with the central axis of the drive nut 84, penetrates through the drive nut 84, and is connected to a drive shaft 86 described later. In this example, the rear portion shaft 89 is inserted into a sleeve 85 having a flange portion 85f, and the sleeve 85 is inserted into a bearing 95 (e.g., a ball bearing) and a thrust bearing 97 (e.g., a thrust ball bearing) fixed to the end bell 80E, whereby the drive nut 84 and the rotor 80R are integrally and rotatably supported inside the stator 80S.

The drive nut 84 has a bottomed hole 84h at the front end thereof. The hole 84h opens toward the second cylinder 12 side and extends along the central axis of the cylindrical shape of the rotor 80R. As described later, a screw thread is formed on the inner peripheral surface that defines the hole 84h. That is, in this embodiment, the drive nut 84 is a member in which an internal thread is formed.

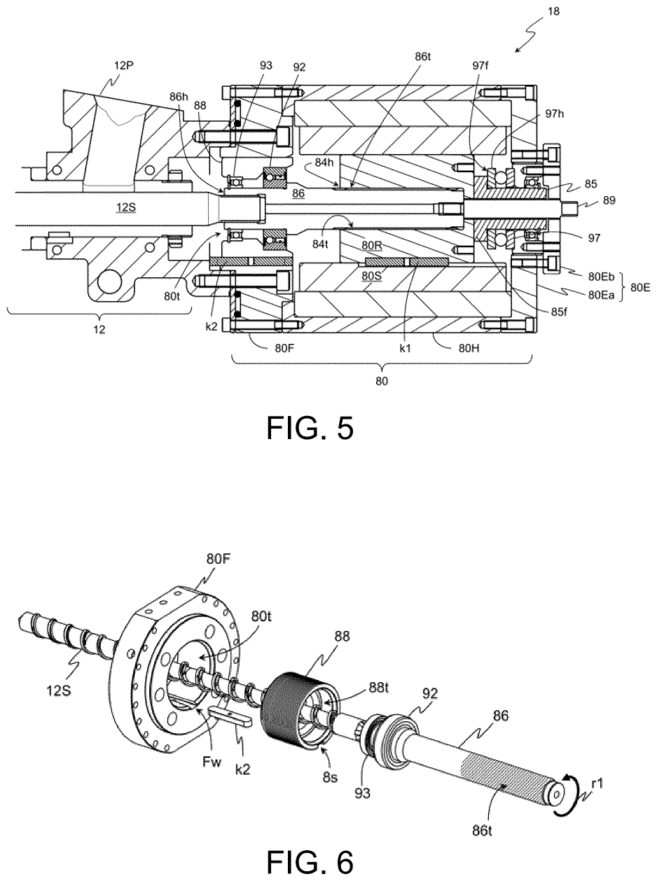

FIG. 5 schematically shows a vertical cross-section of the screw drive device 18. As shown in FIG. 5, the inner peripheral surface of the hole 84h has a screw thread 84t. The screw thread 84t may have a trapezoidal thread shape.

In a typical embodiment of the disclosure, the screw thread 84t may be a reverse thread. In other words, in a typical embodiment of the disclosure, the drive nut 84 is a left-hand thread nut (also called a reverse thread nut). Certainly, it is also possible to use a right-hand thread nut as the drive nut 84. As described later, whether the drive nut 84 is a left-hand thread nut or a right-hand thread nut may be determined in relation to the control of switching the rotation direction of the rotor 80R. The following description continues with the assumption that the screw thread 84t is a left-hand thread.

As shown in FIG. 5, a drive shaft 86 extending in the axial direction of the screw 12S is inserted into the hole 84h of the drive nut 84. A screw thread 86t is provided on a portion of the outer peripheral surface of the drive shaft 86 near the rear end (on the side opposite to the second cylinder 12), and the drive shaft 86 is coupled to the drive nut 84 by engagement (meshing) between the screw thread 86t and the screw thread 84t of the drive nut 84. Here, corresponding to the drive nut 84 being a left-hand thread nut, the screw thread 86t on the outer peripheral surface of the drive shaft 86 is also a left-hand thread (so-called reverse thread). Each of the screw thread 86t of the drive shaft 86 and the screw thread 84t of the drive nut 84 may be a so-called trapezoidal reverse thread.

On the other hand, the front end of the drive shaft 86 is connected to the screw 12S. In the example shown in FIG. 5, a hole 86h is provided at the front end of the drive shaft 86, and the screw 12S is connected to the drive shaft 86 by inserting the rear end of the screw 12S into this hole 86h. The central axis of the drive shaft 86 coincides with the rotation axis of the screw 12S and the central axis of the drive nut 84.

The screw 12S is coupled to the drive shaft 86 by spline connection. That is, the rotation of the drive shaft 86 is transmitted to the screw 12S via the spline, and the screw 12S rotates at the same rotational speed together with the drive shaft 86.

As will be described in detail later with reference to the drawings, one of the roles of the drive shaft 86 is to transmit the rotation of the drive nut 84, which rotates together with the rotor 80R, to the screw 12S in the process of plasticizing and metering thermoplastic molding material, or in the process of mixing and metering thermosetting molding material. The coupling of the screw 12S to the drive shaft 86 may be realized by any means that prevents relative rotation therebetween, and is not limited to spline connection.

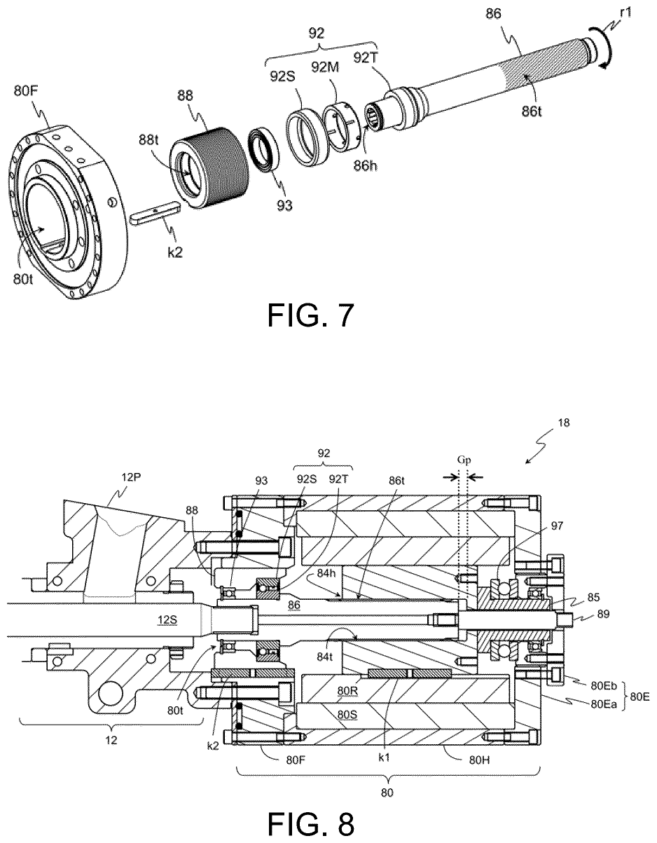

As understood from FIG. 5, the drive shaft 86 penetrates through the front bracket 80F of the motor 80. FIG. 6 and FIG. 7 show the front bracket 80F and its surroundings extracted. As shown in FIG. 6 and FIG. 7, the front bracket 80F is a member provided with a through hole 80t at the central portion, and here, a clutch housing 88 having a through hole 88t at the central portion similarly to the front bracket 80F is disposed inside the through hole 80t of the front bracket 80F (see also FIG. 5).

A bearing 93 that supports the vicinity of the front end of the drive shaft 86 may be mounted to the through hole 88t of the clutch housing 88. For the bearing 93, a ball bearing may be used similarly to the above-mentioned bearing 95.

As shown in FIG. 5, a one-way clutch 92 is mounted inside the through hole 88t of the clutch housing 88 in addition to the bearing 93. As shown in exploded view in FIG. 7, the one-way clutch 92 includes an outer ring 92S, a retainer 92M that holds rollers, sprags, and the like, and an inner ring 92T. The inner ring 92T of the one-way clutch 92 is fixed to the outer peripheral surface of the drive shaft 86 and rotates together with the drive shaft 86. On the other hand, the outer ring 92S of the one-way clutch 92 has its outer peripheral surface fixed to the inner peripheral surface that defines the through hole 88t of the clutch housing 88, thereby restricting relative rotation with respect to the clutch housing 88.

Here, in this embodiment, the clutch housing 88 is coupled to the front bracket 80F in a form that is movable in the axial direction of the screw 12S and has relative rotation with respect to the front bracket 80F restricted. In the example shown in FIG. 4 to FIG. 7, the clutch housing 88 is mounted to the front bracket 80F via a shaft key k2 (second shaft key) in a form that allows movement of the screw 12S in the axial direction. More specifically, the shaft key k2 is disposed between a key sheet 8s provided on the clutch housing 88 and a keyway Fw provided on the front bracket 80F (see FIG. 6). As the shaft key k2, a key of any shape may be applied as long as it may allow movement of the clutch housing 88 in the axial direction of the screw 12S.

As described above, since the front bracket 80F is fixed to the housing 80H of the motor 80 and the rotation of the clutch housing 88 with respect to the front bracket 80F is restricted, the outer ring 92S of the one-way clutch 92 does not rotate relative to the housing 80H of the motor 80. That is, in the embodiment of the disclosure, relative rotation of the outer ring 92S of the one-way clutch 92 with respect to the stator 80S of the motor 80 is restricted.

On the other hand, the inner ring 92T of the one-way clutch 92 is fixed to the drive shaft 86 that penetrates the inner ring 92T. As a result, the rotation direction of the drive shaft 86 is basically restricted to one direction by the one-way clutch 92 having the outer ring 92S fixed to the clutch housing 88. Here, in the embodiment of the disclosure, the direction in which the one-way clutch 92 allows rotation of the inner ring 92T (first direction) is the direction in which the screw thread 86t of the drive shaft 86 tightens according to rotation of the rotor 80R and the drive nut 84 of the motor 80 in that direction. That is, the counterclockwise rotation of the drive shaft 86 (shown by solid arrow r1 in FIG. 6 and FIG. 7) is allowed in the case of viewing in the axial direction from the screw drive device 18 toward the second cylinder 12. In contrast, the clockwise rotation of the drive shaft 86 (rotation in the second direction opposite to the first direction) in the case of viewing in the axial direction from the screw drive device 18 toward the second cylinder 12 is blocked by the one-way clutch 92. It is noted that in this specification, the rotation direction around the axial direction is expressed based on viewing in the axial direction of the screw 12S from the screw drive device 18 toward the second cylinder 12.

### 2. Operation of Screw Drive Device 18

Next, the operation of the screw drive device 18 is described. As is well known, in injection molding using the injection unit 10 that includes two independent cylinders of a cylinder having a screw inside and a cylinder having an injection shaft, roughly the following processes are executed during one shot of molding.
1. A process of plasticizing and metering the input molding material (or a process of mixing and metering liquid main agent and curing agent that constitute liquid molding material)
2. A process of closing the communication path with the screw tip end (backflow prevention operation process)
3. A process of driving the injection shaft to inject molding material from the injection cylinder into the cavity of the mold

### Process of Plasticizing and Metering Molding Material: Rotation of Rotor 80R in First Direction

FIG. 8 schematically shows the arrangement of each portion of the screw drive device 18 before the start of the process of plasticizing molding material (e.g., pellets of thermoplastic resin). As schematically shown in FIG. 8, before the start of the plasticizing process, a gap Gp of a certain size is formed between the bottom surface of the hole 84h of the drive nut 84 and the rear end surface of the drive shaft 86 inserted into the hole 84h. The size of the gap Gp, that is, the distance in the axial direction between the bottom surface of the hole 84h and the rear end surface of the drive shaft 86, is, for example, in a range of 0.5 mm or more and 5.0 mm or less, preferably in a range of 1.0 mm or more and 2.0 mm or less.

In the plasticizing process, the control unit 30 (see FIG. 1) sends a drive signal to the screw drive device 18 so that the rotation direction of the screw 12S becomes the above-mentioned first direction. The screw drive device 18 receives the drive signal from the control unit 30 and rotates the rotor 80R of the motor 80 in the first direction. The drive of the rotor 80R at this time is transmitted from the drive nut 84 coupled to the rotor 80R by the shaft key k1 to the drive shaft 86 via the screw thread 86t.

As described with reference to FIG. 5 to FIG. 7, the first direction is the direction in which the screw thread 86t of the drive shaft 86 tightens in response to rotating the drive nut 84 together with the rotor 80R of the motor 80 in that direction. Thus, in response to the drive nut 84 rotating in the first direction with the rotation of the rotor 80R, since the drive nut 84 is a left-hand thread nut here, a force acting toward the right side in the figure works on the drive shaft 86 due to the engagement between the screw thread 84t and the screw thread 86t. That is, although the drive nut 84 may idle relative to the drive shaft 86 at the beginning of the rotation of the rotor 80R, the drive shaft 86 is soon drawn into the hole 84h of the drive nut 84, and the drive shaft 86 moves toward the right side in the figure.

Here, as described with reference to FIG. 6 and FIG. 7, the one-way clutch 92 allows rotation of the inner ring 92T, to which the vicinity of the front end of the drive shaft 86 is fixed, in the first direction. Furthermore, the clutch housing 88 that holds the one-way clutch 92 is mounted to the front bracket 80F by coupling via the shaft key k2. In other words, the outer ring 92S of the one-way clutch 92 is movable in the axial direction of the screw 12S similarly to the clutch housing 88. Thus, with the movement of the drive shaft 86, the one-way clutch 92 as a whole moves toward the right side in the figure together with the clutch housing 88.

In response to the reverse thread of the drive nut 84 and the drive shaft 86 being completely tightened, the movement of the drive shaft 86 toward the right side in the figure stops, and the arrangement of the drive shaft 86, the one-way clutch 92, and the clutch housing 88 becomes the same arrangement as shown in FIG. 5 described above. In response to the reverse thread being completely tightened and the movement of these members in the axial direction stopping, the rotation of the rotor 80R and the drive nut 84 in the first direction is directly transmitted to the drive shaft 86. That is, the drive shaft 86 rotates in the first direction at a rotational speed that matches the rotor 80R and the drive nut 84. It is noted that, at this time, the rear end surface of the drive shaft 86 does not need to contact the bottom surface of the hole 84h. It is naturally possible that the size of the gap Gp is not 0.

As described above, the rotation of the drive shaft 86 in the first direction is free without being restricted by the one-way clutch 92. Since the screw 12S is coaxially spline-connected to the front end of the drive shaft 86, the screw 12S rotates together with the drive shaft 86 in the first direction with a predetermined torque. Due to the rotation of the screw 12S in the first direction, the molding material fed from the hopper 12P is plasticized by being heated by the heater 12H (see FIG. 3) while receiving shear force from the screw 12S, and is sent toward the front end of the second cylinder 12.

It is noted that in response to the screw 12S starting to rotate, the screw 12S receives a force toward the right side in the figure due to reaction force from the resin. Thus, the operation of the drive shaft 86 from the start of movement to the stop of movement along the axial direction may occur in a relatively short period. It is noted that during the period until the movement of the drive shaft 86 along the axial direction completely stops, the movement of the drive shaft 86 may be accompanied by lower-speed rotation in the first direction.

Along with the rotation of the screw 12S in the first direction, the plasticized molding material is sent from the second cylinder 12 to the first cylinder 11 via the communication path 142 inside the nozzle cylinder 14 and inside the junction 14Bb (see FIG. 3). The control unit 30 detects completion of metering of the molding material by a predetermined amount of retreat of the injection shaft 11A (here, the injection plunger) inside the first cylinder 11, or by temporal control.

### Process of Blocking the Communication Path 142 (Backflow Prevention Operation): Switching of Rotation Direction of Rotor 80R

In response to detecting completion of metering of the molding material, the control unit 30 causes the injection unit 10 to start the backflow prevention operation. In this embodiment, the control unit 30 sends a drive signal to the screw drive device 18 to reverse the rotation direction of the rotor 80R from the first direction to the second direction.

Referring to FIG. 5. In response to the motor 80 reversing the rotation direction of the rotor 80R, the drive shaft 86 (and the screw 12S connected to the drive shaft 86) that had been rotating integrally with the drive nut 84 due to the engagement of the reverse thread also attempts to rotate in the second direction. However, the rotation of the drive shaft 86 in the second direction is prevented by the one-way clutch 92 having the inner ring 92T fixed to the drive shaft 86. That is, the rotor 80R and the drive nut 84 rotate integrally in the second direction in a state where the rotation of the drive shaft 86 is stopped.

Here, since the first direction is the direction in which the screw thread 86t of the drive shaft 86 tightens in response to the drive nut 84 being rotated in that direction, in response to the drive nut 84 rotating in the second direction together with the rotor 80R, the screw thread 86t of the drive shaft 86 begins to loosen. This means that a force acts on the drive nut 84 and the drive shaft 86 in a direction in which they separate from each other in the axial direction.

However, here, the sleeve 85 having the flange portion 85f is positioned at the rear end of the drive nut 84, and the flange portion 85f of the sleeve 85 faces the housing raceway plate 97h of the thrust bearing 97. As shown in FIG. 5, the thrust bearing 97 restricts the rearward movement of the screw drive device 18 by contacting the end bell 80E (particularly the second member 80Eb in this case), and together with the end bell 80E, it functions as a restricting member that restricts the rearward movement of the drive nut 84 to which the sleeve 85 is attached.

That is, in response to the screw thread 86t of the drive shaft 86 beginning to loosen, the drive shaft 86 and the drive nut 84 attempt to start moving in directions away from each other, and the flange portion 85f contacts the surface 97f (contact surface) of the housing raceway plate 97h. That is, the housing raceway plate 97h of the thrust bearing 97 receives the rear end of the drive nut 84 via the flange portion 85f of the sleeve 85, and movement of the drive nut 84 toward the end bell 80E is prevented by the thrust bearing 97 supported by the end bell 80E.

As a result, the drive shaft 86 and the screw 12S connected to the drive shaft 86 receive a force toward the left side of the figure and move along the axial direction. As understood from the description so far, since the clutch housing 88 that holds the one-way clutch 92 is coupled to the front bracket 80F via the shaft key k2, the one-way clutch 92 is slidable in the axial direction similarly to the clutch housing 88. That is, the screw 12S, the drive shaft 86, the one-way clutch 92, and the clutch housing 88 are integrally pushed out from the drive nut 84 toward the front (here, the left side of the figure) by the rotation of the drive nut 84 in the second direction.

In this manner, in response to the drive nut 84 beginning to rotate in the second direction, the torque applied to the drive nut 84 is converted into a force in the axial direction by the screw thread 84t, and the drive shaft 86 and the screw 12S move toward the left side of the figure (in other words, toward the front end of the second cylinder 12). By the screw 12S, the one-way clutch 92, the bearing 93, and the clutch housing 88 moving forward integrally together with the drive shaft 86, the arrangement of these members returns from the state shown in FIG. 5 to the state shown in FIG. 8. By the screw 12S advancing together with the drive shaft 86, the tip end of the screw 12S is pressed against the inlet of the communication path 142, and the communication path 142 is blocked by the tip end of the screw 12S.

### Process of Injecting Molding Material Into Cavity: Stopping Of Rotor 80R

In response to the completion of blocking the communication path 142, the control unit 30 operates the injection drive device 11D of the injection unit 10 to push out the injection plunger as the injection shaft 11A toward the front, thereby injecting the measured molding material into the cavity of the mold via the flow path 141 (see FIG. 3). The completion of blocking the communication path 142 may be detected, for example, by monitoring the load of the motor 80 through changes in current values and the like. By detecting the completion of blocking the communication path 142 and reducing the rotation number of the rotor 80R or stopping the rotation of the rotor 80R, problems such as member damage caused by excessive pressing of the screw 12S may be avoided. Furthermore, in the configurations illustrated in FIG. 5 and FIG. 8, since the rear end of the rear portion shaft 89 is exposed from the second member 80Eb of the end bell 80E, the rotation and back-and-forth movement of the screw 12S connected via the drive shaft 86 may be visually grasped by observing the rear end of the rear portion shaft 89.

The process of injecting molding material into the cavity is generally called the injection process. The injection process includes at least a filling process. The filling process is a process of greatly advancing the injection plunger to fill the molding material into an empty cavity. In many cases, the injection process further includes a holding pressure process. The holding pressure process is a process of applying a predetermined holding pressure to the molding material in the mold by continuing to push out the injection plunger forward from the filling process until the portion of the molding material that is in the gate of the mold solidifies or cures. The implementation of the holding pressure process prevents backflow of the molding material filled in the portion related to the product (portions other than gates, runners, etc.) in the space of the mold toward the injection unit 10 side, and to replenish molding material to the above-mentioned portion in the space of the mold to compensate for shrinkage in the initial stage of solidification or curing. The blocking of the communication path 142 by the tip end of the screw 12S also exhibits effectiveness in preventing backflow of molding material into the interior of the second cylinder 12 in the holding pressure process.

The blocking of the communication path 142 by the screw 12S is continued at least during the period of discharge of molding material from the injection nozzle 16. The period of discharge of molding material from the injection nozzle 16 is, for example, the period during which the aforementioned injection process is implemented. At this time, the control unit 30 may control the driving of the motor 80 so as to continue applying a constant torque to the rotor 80R. It is noted that the motor 80 may have a brake mechanism for temporarily restricting the rotation of the rotor 80R. The control unit 30 may execute control to operate the brake mechanism during the period of discharge of molding material so that the rotor 80R does not rotate. Thereafter, the control unit 30 waits for cooling of the molding material, operates the mold clamping unit 20, and discharges the molded product from the mold.

One shot of molding is completed by the cycle including the above processes. Thereafter, by switching the rotation direction of the rotor 80R back to the first direction and operating the motor 80, the screw 12S may be retracted while also utilizing the reaction force from the resin that occurs with plasticization. By the retraction of the screw 12S, the blocking of the communication path 142 by the tip end of the screw 12S is also released.

As described above, in the embodiment of the disclosure, the screw 12S is rotated in the first direction by rotating the rotor 80R of the motor 80 in the first direction, and the molding material in the second cylinder 12 is sent to the first cylinder 11 via the communication path 142. Furthermore, after the transfer of the molding material to the first cylinder 11, the operation of the motor 80 is controlled to rotate the rotor 80R in the second direction opposite to the first direction. By switching the rotation to the second direction, through the cooperation of the action of the reverse thread formed on the drive nut 84 and the drive shaft 86 and the rotation restriction action of the one-way clutch 92, the screw 12S is advanced along the axial direction, and the communication path 142 is blocked at the tip end of the screw 12S. According to the embodiment of the disclosure, while having a simpler configuration, it is possible to achieve switching between rotation and back-and-forth movement of the screw 12S by relatively simple control of switching the rotation direction of the motor 80.

According to the typical embodiment of the disclosure, since the rotation of the rotor 80R is converted to the forward movement of the screw 12S through the engagement of screw threads, the tip end of the screw 12S may be pressed against the inlet of the communication path 142 with sufficient force, and backflow of the plasticized molding material from the first cylinder 11 to the second cylinder 12 may be strongly suppressed. It is noted that in the typical embodiment, the rotation number of the screw 12S may be arbitrarily set in the range of 0 to 400 rpm, and the ratio of the rotation number during rotation in the second direction to that during rotation in the first direction of the rotor 80R and the drive nut 84 may be, for example, in the range of 0.3 or more and 15 or less. As an example, the rotation number of the rotor 80R and the drive nut 84 during rotation in the second direction may be set to about 120 rpm in the case where the lead of the screw thread 86t of the drive shaft 86 is 3 mm and the operation of advancing the screw 12S by 1.5 mm along the axial direction to block the communication path 142 at the tip end of the screw 12S is to be performed in 0.25 seconds.

In the embodiment of the disclosure, an electric direct drive motor capable of exhibiting high torque is applied to the motor 80, and by being a hollow motor, the space generated around the rotation axis is utilized in reverse, and the configuration for switching the operation of the screw 12S is basically accommodated within this space. According to the embodiment of the disclosure, since the operation of the screw 12S does not require configurations such as multiple motors, multiple one-way clutches, or hydraulic systems, it is advantageous for miniaturization of the injection unit 10. In particular, it is possible to make the size of the screw drive device 18 smaller than conventional ones with respect to the axial direction of the screw 12S.

In the embodiment of the disclosure, by adopting an electric direct drive motor, a hydraulic system is not required for driving the screw 12S of the second cylinder 12. By basically not requiring a hydraulic system, problems such as deterioration of packing in the hydraulic cylinder due to heat transfer from the second cylinder 12 (particularly from the hopper 12P) may be avoided, and for example, there is no concern about oil leakage caused by deterioration of the packing. Further, it becomes possible to raise the upper limit of the set temperature of the cooling device inside the hopper 12P, and effects of energy saving through improved plasticizing efficiency and reduced heat transfer loss may be expected.

Furthermore, since basically only switching of the rotation direction of the rotor 80R is required for process transition, and incorporation of a reduction gear is not required, the time for switching operations is short, and power transmission loss and noise are also reduced. By utilizing trapezoidal screws and shaft keys for coupling members, concentration of stress accompanying power transmission at local areas may also be avoided.

### 3. Improvement of Maintainability of Injection unit 10

In typical embodiments of the disclosure, since a hydraulic system is not required for the operation of the screw 12S and the mechanical configuration is not complex, maintenance of each portion, for example, access to the inside of the housing 80H of the motor 80, is easier compared to conventional systems. This point will be described below.

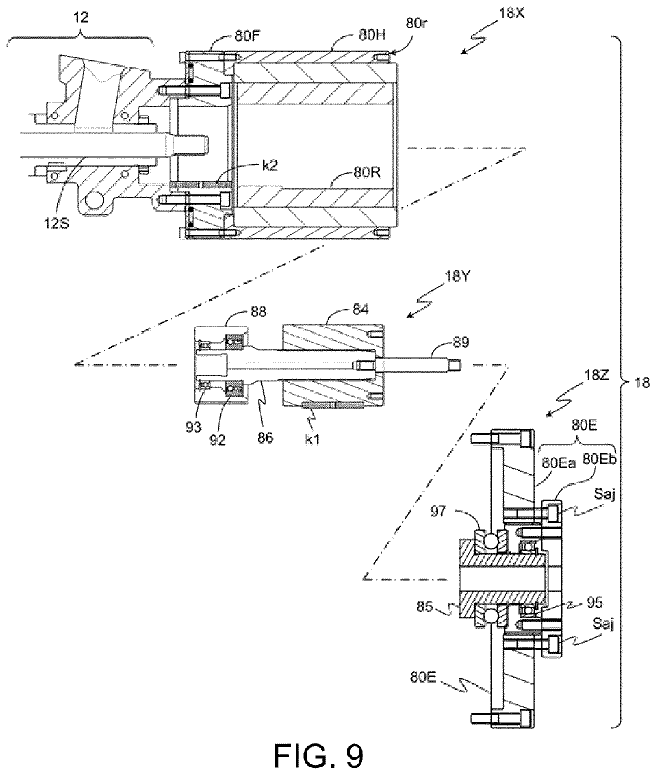

FIG. 9 shows the screw drive device 18 in an exploded view. As shown in FIG. 9, the screw drive device 18 may be disassembled into three units, for example, an outer unit 18X, an inner unit 18Y, and an end unit 18Z.

As described with reference to FIG. 4, the end bell 80E of the motor 80 may be fixed to the housing 80H by, for example, screw fastening. Thus, by loosening the screws inserted into the screw holes of the end bell 80E, the end bell 80E may be separated from the rear end 80r of the housing 80H. At this time, the sleeve 85 may be separated together with the end bell 80E from the rear portion shaft 89 extending from the rear end of the drive nut 84.

Next, by pulling out the shaft key k1 and the shaft key k2, the coupling of the drive nut 84 to the rotor 80R and the coupling of the clutch housing 88 to the front bracket 80F may be released, respectively. Furthermore, by separating the drive shaft 86 from the screw 12S, the set of the clutch housing 88, the bearing 93, the one-way clutch 92, the drive shaft 86, the drive nut 84, and the rear portion shaft 89 may be integrally pulled out from the rotor 80R of the motor 80 as the inner unit 18Y. By making the diameter of the clutch housing 88 equal to or less than the diameter of the drive nut 84, integral removal of the inner unit 18Y from inside the motor 80 becomes possible.

By removing the inner unit 18Y, access to the inside of the motor 80 from the rear end 80r side of the housing 80H becomes possible. In this example, since the screw 12S may be easily accessed by removing the inner unit 18Y, pulling out the screw 12S from the second cylinder 12 is also relatively easy.

### Adjustment of Stroke Width of Screw 12s in Backflow Prevention Operation

As described above, here, the drive nut 84 is coupled to the rotor 80R of the motor 80 via the shaft key k1. The drive nut 84 may be allowed to move along the axial direction of the screw 12S by being coupled to the rotor 80R via the shaft key k1. However, unlike the clutch housing 88, it is not essential for the embodiments of the disclosure that the drive nut 84 be movable relative to the rotor 80R along the axial direction of the screw 12S during operation of the injection unit 10.

The position of the drive nut 84 inside the rotor 80R in the axial direction determines the movement amount of the screw 12S along the axial direction (stroke of the screw 12S). The magnitude of this stroke is the distance of movement of the screw 12S between a state where the drive shaft 86 is most drawn into the hole 84h of the drive nut 84 by rotation of the rotor 80R in the first direction and a state where the tip end of the screw 12S abuts against the inlet of the communication path 142. A typical example of the magnitude of the stroke is in the range of 0.5 mm or more and 5.0 mm or less, and more preferably in the range of 1.0 mm or more and 2.0 mm or less (approximately 1.5 mm in this embodiment).

During operation of the injection unit 10, a force basically acts on the drive nut 84 toward the end bell 80E regardless of the rotation direction of the rotor 80R. Thus, by adjusting the position of the retractable limit of the drive nut 84 in the axial direction, it is possible to determine the limit of how far the screw 12S may be retracted. In other words, the stroke of the screw 12S may be adjusted by adjusting the position of the rear end of the drive nut 84.

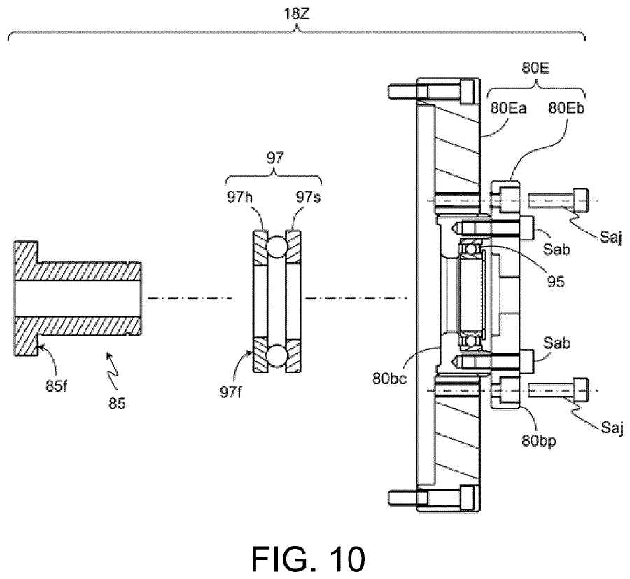

For example, as understood from the comparison between FIG. 8 and FIG. 5, how close the drive nut 84 may be brought to the end bell 80E inside the rotor 80R depends on the position of the thrust bearing 97 in the axial direction. By disassembling the end unit 18Z as shown in FIG. 10, here, the end bell 80E includes two parts: an annular first member 80Ea fixed to the housing 80H, and a second member 80Eb having a cylindrical portion 80bc inserted into the central portion of the first member 80Ea. The thrust bearing 97 is restricted from further movement toward the rear end side of the injection unit 10 (right side in FIG. 10) by the shaft washer 97s of the thrust bearing 97 contacting the cylindrical portion 80bc of the second member 80Eb.

As clearly shown in FIG. 10, in the configuration illustrated in FIG. 9 and FIG. 10, the second member 80Eb is composed of two members: the above-mentioned cylindrical portion 80bc and a plate portion 80bp that covers the opening of the first member 80Ea. Here, screw threads are formed on the outer peripheral surface of the cylindrical portion 80bc and the inner peripheral surface that defines the opening of the first member 80Ea, and the cylindrical portion 80bc is mounted to the first member 80Ea by coupling through these screw threads. Thus, by rotation of the cylindrical portion 80bc around the axial direction, the depth of insertion of the cylindrical portion 80bc into the opening of the first member 80Ea may be adjusted. For example, by making the insertion of the cylindrical portion 80bc shallower, the position of the cylindrical portion 80bc relative to the rear end of the housing 80H may be made more rearward.

On the other hand, the plate portion 80bp is positioned rearward of the cylindrical portion 80bc and may have a larger diameter than the cylindrical portion 80bc. After adjusting the depth of insertion of the cylindrical portion 80bc into the opening of the first member 80Ea, the plate portion 80bp is fixed to the first member 80Ea by bolts Saj, as in the example shown in FIG. 9. In this state, the rear end surface of the cylindrical portion 80bc is in contact with the plate portion 80bp, and thus, rotation of the cylindrical portion 80bc relative to the opening of the first member 80Ea is restricted by the frictional force between the rear end surface of the cylindrical portion 80bc and the surface of the plate portion 80bp. That is, the plate portion 80bp fixed to the first member 80Ea functions to restrict the forward and rearward movement of the cylindrical portion 80bc after adjustment of the insertion depth. Thus, in this embodiment, the position of the cylindrical portion 80bc in the axial direction relative to the rear end of the housing 80H is adjustable. As described later, the plate portion 80bp may also be used as a tool for rotating the cylindrical portion 80bc in mounting the cylindrical portion 80bc to the opening of the first member 80Ea.

By positioning the cylindrical portion 80bc of the second member 80Eb, for example, more rearward, the position of the thrust bearing 97 that contacts the cylindrical portion 80bc also becomes more rearward. As the thrust bearing 97 is moved rearward, the position of the surface 97f of the housing raceway plate 97h that the flange portion 85f of the sleeve 85 contacts becomes more rearward, resulting in the rearward limit of the drive nut 84 also shifting rearward. Thus, in this embodiment, the thrust bearing 97 as a restricting member is configured such that the position of the contact surface in the axial direction relative to the rear end of the housing 80H is adjustable.

By making the position in the axial direction of the contact surface of the thrust bearing 97 adjustable, the stroke of the forward and backward movement of the screw 12S in one shot cycle may be adjusted afterwards. The respective lengths of the shaft key k1, the key sheet 4s, and the keyway Rw (see FIG. 4, for example) may be appropriately determined within a range that may secure the necessary stroke. The length of the keyway Rw along the axial direction may be in a range of, for example, 1.0 times to 2.0 times the length of the shaft key k1, preferably in a range of 1.2 times to 1.8 times. The drive nut 84 may be movable relative to the rotor 80R in the axial direction of the screw 12S within a range larger than the stroke of the screw 12S.

### Mounting of Cylindrical Portion 80bc to Opening of First Member 80ea

In mounting the cylindrical portion 80bc to the opening of the first member 80Ea and in adjusting the insertion depth of the cylindrical portion 80bc, as schematically shown in FIG. 10, the bolt Saj for coupling the plate portion 80bp to the first member 80Ea is removed from these members. At this time, the plate portion 80bp may be temporarily fixed to the cylindrical portion 80bc by the bolt Sab, as illustrated in FIG. 10. By coupling the cylindrical portion 80bc to the plate portion 80bp with the bolt Sab, it becomes possible to rotate the cylindrical portion 80bc together with the plate portion 80bp. This facilitates rotation of the cylindrical portion 80bc relative to the opening of the first member 80Ea.

As shown in FIG. 4, at least one bolt hole Bh may be formed on the outer peripheral surface of the plate portion 80bp. By providing the bolt hole Bh on the outer peripheral surface of the plate portion 80bp, in adjusting the insertion depth of the cylindrical portion 80bc, a bolt may be mounted to the bolt hole Bh and the bolt may be used as a handle to rotate the plate portion 80bp, making rotation of the cylindrical portion 80bc using the plate portion 80bp easier.

After adjusting the insertion depth of the cylindrical portion 80bc, the bolt Sab is removed from the cylindrical portion 80bc, and as shown in FIG. 9, the plate portion 80bp is fixed to the first member 80Ea by the bolt Saj while pressing the plate portion 80bp against the cylindrical portion 80bc. This restricts further rotation of the cylindrical portion 80bc relative to the first member 80Ea. It is noted that the plate portion 80bp may be fixed to the first member 80Ea by the bolt Saj in a state where the cylindrical portion 80bc and the plate portion 80bp are coupled by the bolt Sab. However, according to the configuration in which after adjusting the insertion depth of the cylindrical portion 80bc, the coupling between the cylindrical portion 80bc and the plate portion 80bp by the bolt Sab is released and the plate portion 80bp is fixed to the first member 80Ea by the bolt Saj, an advantage is obtained that fine adjustment of the rotation of the cylindrical portion 80bc may be facilitated.

It is of course possible to adopt a configuration different from this embodiment as a configuration for making the position of the cylindrical portion 80bc adjustable in the axial direction and for fixing the cylindrical portion 80bc at the adjusted position. For example, an appropriate spacer may be interposed between the plate portion 80bp and the first member 80Ea.

Various embodiments according to the disclosure have been described above, but these are presented as examples and are not intended to limit the scope of the disclosure. Novel embodiments may be implemented in various other forms, and various omissions, replacements, and changes may be made without departing from the gist of the disclosure. The embodiments and their modifications are included in the scope and gist of the disclosure, and are included in the disclosure described in the claims and the equivalent scope thereof. For example, in the above-described embodiments, the screw thread 84t and the screw thread 86t are left-hand threads, but these may be right-hand threads. In that case, the direction in which the one-way clutch 92 allows rotation of the inner ring 92T may be reversed from the direction in the above-described embodiments.

What is claimed is:

1. An injection molding machine having a first cylinder having an injection shaft and a second cylinder connected to the first cylinder via a communication path, the injection molding machine comprising:
a screw accommodated inside the second cylinder;
a drive shaft having a screw thread on an outer peripheral surface;
an electric motor having a stator and a rotor; and
a one-way clutch having an outer ring and an inner ring,
wherein the outer ring of the one-way clutch is movable in an axial direction of the screw and restricted from relative rotation with respect to the stator,
the inner ring of the one-way clutch is fixed to the drive shaft,
the drive shaft is connected to a rear end of the screw coaxially with the screw,
driving of the rotor is transmitted to the drive shaft via the screw thread, and
a first direction in which the one-way clutch allows rotation of the inner ring is a direction in which the screw thread tightens in response to rotating the rotor in the first direction.

2. The injection molding machine according to claim 1, wherein
the electric motor is controlled to rotate the screw in the first direction by rotating the rotor in the first direction to send molding material in the second cylinder to the first cylinder via the communication path, and then advance the screw along the axial direction by rotating the rotor in a second direction opposite to the first direction to close the communication path at a tip end of the screw.

3. The injection molding machine according to claim 1, wherein
the screw thread provided on the drive shaft is a reverse thread.

4. The injection molding machine according to claim 1, the injection molding machine further comprising:
a first shaft key; and
a drive nut formed with an internal thread,
wherein the rotor of the electric motor has a hollow cylindrical shape,
the drive nut is coupled to an inside of the cylindrical shape of the rotor with relative rotation with respect to the rotor being restricted by the first shaft key, and
the screw thread of the drive shaft is engaged with the internal thread of the drive nut.

5. The injection molding machine according to claim 4, the injection molding machine further comprising:
a second shaft key; and
a clutch housing fixed to an outer peripheral surface of the outer ring of the one-way clutch,
wherein the electric motor comprises:
a housing that accommodates the stator and the rotor; and
a front bracket having a through hole,
the front bracket is positioned between the housing and the second cylinder, and
the clutch housing is coupled to an inside of the through hole such that the clutch housing is movable in the axial direction of the screw by the second shaft key and relative rotation with respect to the front bracket is restricted.

6. The injection molding machine according to claim 5, wherein
a diameter of the clutch housing is equal to or less than a diameter of the drive nut.

7. The injection molding machine according to claim 6, wherein
the electric motor further comprises an end bell connected to a rear end of the housing,
the end bell comprises a restriction member having a contact surface,
the restriction member is configured to be capable of adjusting a position of the contact surface in the axial direction of the screw with respect to a rear end of the housing, and
the drive nut is coupled to the rotor movably in the axial direction of the screw by the first shaft key.

8. The injection molding machine according to claim 1, wherein
the first cylinder is an injection cylinder,
the injection shaft is an injection plunger,
the second cylinder is a plasticizing cylinder, and
the screw is a plasticizing screw.

9. The injection molding machine according to claim 1, wherein
the first cylinder is an injection cylinder,
the injection shaft is an injection plunger,
the second cylinder is a mixing cylinder, and
the screw is a mixing screw.

10. The injection molding machine according to claim 2, the injection molding machine further comprising:
a first shaft key; and
a drive nut formed with an internal thread,
wherein the rotor of the electric motor has a hollow cylindrical shape,
the drive nut is coupled to an inside of the cylindrical shape of the rotor with relative rotation with respect to the rotor being restricted by the first shaft key, and
the screw thread of the drive shaft is engaged with the internal thread of the drive nut.

11. The injection molding machine according to claim 2, wherein
the screw thread provided on the drive shaft is a reverse thread.

12. The injection molding machine according to claim 11, the injection molding machine further comprising:
a first shaft key; and
a drive nut formed with an internal thread,
wherein the rotor of the electric motor has a hollow cylindrical shape,
the drive nut is coupled to an inside of the cylindrical shape of the rotor with relative rotation with respect to the rotor being restricted by the first shaft key, and
the screw thread of the drive shaft is engaged with the internal thread of the drive nut.

13. The injection molding machine according to claim 12, the injection molding machine further comprising:
a second shaft key; and
a clutch housing fixed to an outer peripheral surface of the outer ring of the one-way clutch,
wherein the electric motor comprises:
a housing that accommodates the stator and the rotor; and
a front bracket having a through hole,
the front bracket is positioned between the housing and the second cylinder, and
the clutch housing is coupled to an inside of the through hole such that the clutch housing is movable in the axial direction of the screw by the second shaft key and relative rotation with respect to the front bracket is restricted.

14. The injection molding machine according to claim 13, wherein
a diameter of the clutch housing is equal to or less than a diameter of the drive nut.

15. The injection molding machine according to claim 14, wherein
the electric motor further comprises an end bell connected to a rear end of the housing,
the end bell comprises a restriction member having a contact surface,
the restriction member is configured to be capable of adjusting a position of the contact surface in the axial direction of the screw with respect to a rear end of the housing, and
the drive nut is coupled to the rotor movably in the axial direction of the screw by the first shaft key.

16. The injection molding machine according to claim 15, wherein
the first cylinder is an injection cylinder,
the injection shaft is an injection plunger,
the second cylinder is a plasticizing cylinder, and
the screw is a plasticizing screw.

17. The injection molding machine according to claim 15, wherein
the first cylinder is an injection cylinder,
the injection shaft is an injection plunger,
the second cylinder is a mixing cylinder, and
the screw is a mixing screw.
